(19) United States
(12) Patent Application Publication
(10) Pub. No.: US 2026/0211966 A1
(43) Pub. Date: Jul. 23, 2026

(54) MANAGING SHARED CONTENT BASED ON LINK STATUS

(71) Applicant: Motorola Mobility LLC, Chicago, IL (US)

(72) Inventors: Amit Kumar Agrawal, Bangalore (IN); Vijayprakash Idlur, Bangalore (IN); Panduranga Reddy Pailla, Bangalore (IN)

(73) Assignee: Motorola Mobility LLC, Chicago, IL (US)

(21) Appl. No.: 19/035,722

(22) Filed: Jan. 23, 2025

(51) Int. Cl. G06F 16/957; G06F 16/955; G06Q 50/00

(52) U.S. Cl. CPC G06F 16/9574; G06F 16/9566; G06Q 10/40

(57) ABSTRACT

Techniques for managing shared content based on link status are described and are implementable to maintain content accessibility. For example, an instance of digital content that includes a hyperlink associated with destination content is generated, such as for presentation by a network-based content sharing platform. Cached content that includes a representation of the hyperlink and metadata associated with the destination content is generated for caching by a client device. A status of the hyperlink is monitored while the instance of digital content is presented. Responsive to a detection that the hyperlink is invalid, an alternative hyperlink associated with the destination content is identified. The instance of digital content is then updated to include the alternative hyperlink.

### BACKGROUND

Social media platforms and content sharing applications have become ubiquitous and enable rapid dissemination of web-based content through posts containing text, images, videos, and hyperlinks. These platforms often support content sharing with minimal restriction, resulting in a vast ecosystem of interconnected digital resources. However, the dynamic nature of web-based content poses significant challenges for maintaining integrity of shared information over time. For instance, hyperlinks embedded in social media posts may become invalid due to various factors such as content removal, website restructuring, domain changes, etc. Broken links and/or inaccessible resources diminish a value of the shared content and negatively impact credibility of the original poster and the platform itself. Conventional content management systems lack mechanisms to detect and address these issues, and instead require manual intervention which is time-consuming, computationally inefficient, and often impractical task given a volume of content shared across social networks.

### BRIEF DESCRIPTION OF THE DRAWINGS

Aspects of managing shared content based on link status are described with reference to the following Figures. The same numbers may be used throughout to reference similar features and components that are shown in the Figures:

FIG. 1 illustrates an example environment in which aspects of managing shared content based on link status can be implemented.

FIG. 2 depicts an example system for managing shared content based on link status in accordance with one or more implementations.

FIG. 3 depicts an example implementation for managing shared content based on link status in accordance with one or more implementations.

FIG. 4 depicts an example implementation for managing shared content based on link status in which a hyperlink has become invalid accordance with one or more implementations.

FIG. 5 depicts an example implementation for managing shared content based on link status in which an alternative hyperlink is identified in accordance with one or more implementations.

FIG. 6 depicts an example implementation for managing shared content based on link status in which a hyperlink has become invalid in accordance with one or more implementations.

FIGS. 7a and 7b depict example implementations for managing shared content based on link status in which an instance of digital content with an invalid hyperlink is edited in accordance with one or more implementations.

FIG. 8 depicts a flow chart depicting an example method for managing shared content based on link status in accordance with one or more implementations.

FIG. 9 depicts a flow chart depicting an example method for managing shared content based on link status in which availability of an alternative hyperlink is determined in accordance with one or more implementations.

FIG. 10 illustrates various components of an example device in which aspects of managing shared content based on link status can be implemented in accordance with one or more implementations.

### DETAILED DESCRIPTION

Techniques for managing shared content based on link status are described. The described implementations, for instance, support dynamic monitoring and updating of hyperlinks within digital content shared on network-based content sharing platforms. In this way, the described implementations enable real-time detection of invalid hyperlinks and automatic replacement with alternative hyperlinks and/or removal of the digital content, thereby maintaining integrity and relevance of shared information.

According to various implementations, a client device generates an instance of digital content (e.g., a social media post) for presentation by a network-based content sharing platform (e.g., a social media platform) that includes a hyperlink associated with destination content. The client device then generates cached content that includes a representation of the hyperlink as well as metadata associated with the destination content. The cached content, for instance, includes a resource non-intensive representation of the destination content, such as to facilitate efficient searching and matching operations as further described in more detail below. While the instance of digital content is presented by the network-based content sharing platform, the client device monitors a status of the hyperlink.

By way of example, a user leverages the client device to create a social media post about a news story, including a hyperlink to destination content that includes an article about the news story on a news website. The client device caches a variety of metadata about the article, such as a title, an author, an article length, a content summary, etc. As the post gains traction and receives interactions such as comments and/or “likes.” The client device periodically determines a validity of the hyperlink to ensure the hyperlink remains valid. The client device is further operable to update the cached content, such as at predetermined intervals.

Continuing with the example, the client device automatically checks the validity of the hyperlink based on one or more interactions with the post, such as a comment that indicates that the destination content is not available. Responsive to detection that the hyperlink has become invalid, the client device searches for alternative hyperlinks that are associated with digital content that is substantially similar to the destination content based on the cached content. For instance, the client device generates a search query using the cached content to identify one or more candidate hyperlinks and compares digital content associated with the candidate hyperlinks to the initial destination content to identify a suitable replacement hyperlink.

Upon identification an appropriate alternative hyperlink, the client device automatically updates the instance of digital content to include the new hyperlink. This process occurs without user intervention to ensure that the shared digital content remains current and accessible. In examples in which an alternative hyperlink is not available, the client device may remove the instance of digital content from display and/or notify the user of the invalid hyperlink.

In this way, the described techniques overcome limitations of conventional techniques that are reliant on manual intervention to review posts to enhance a user experience, maintain credibility of shared content, and reduce spread of misinformation due to outdated or broken links. Further, generation and caching of resource non-intensive cached content supports computationally efficient hyperlink replacement and ensures that content associated with the alternative hyperlink is substantially similar to the initial destination content. This preserves an intent of the original post while adapting to the dynamic nature of web-based information.

While features and concepts of managing shared content based on link status can be implemented in any number of environments and/or configurations, aspects of managing shared content based on link status are described in the context of the following example systems, devices, and methods.

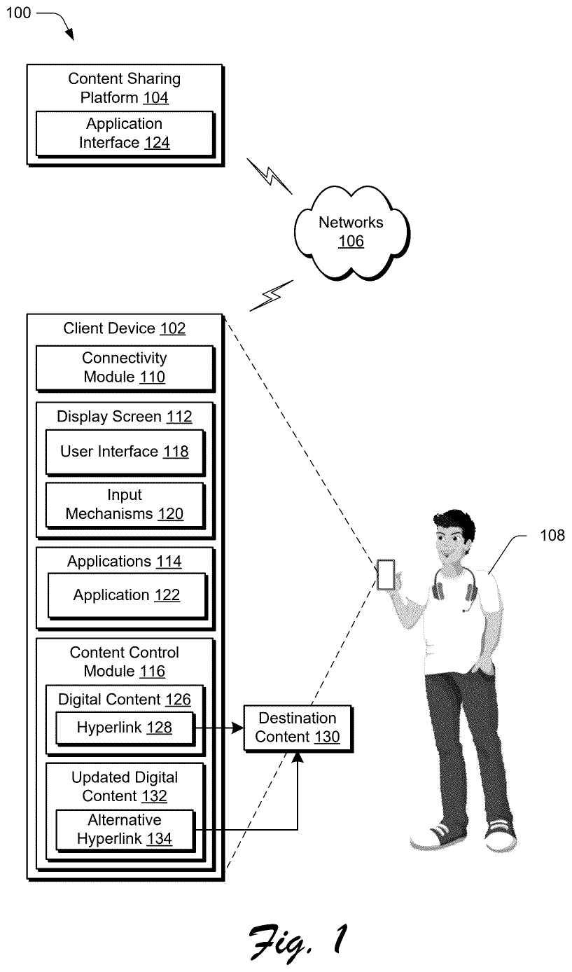

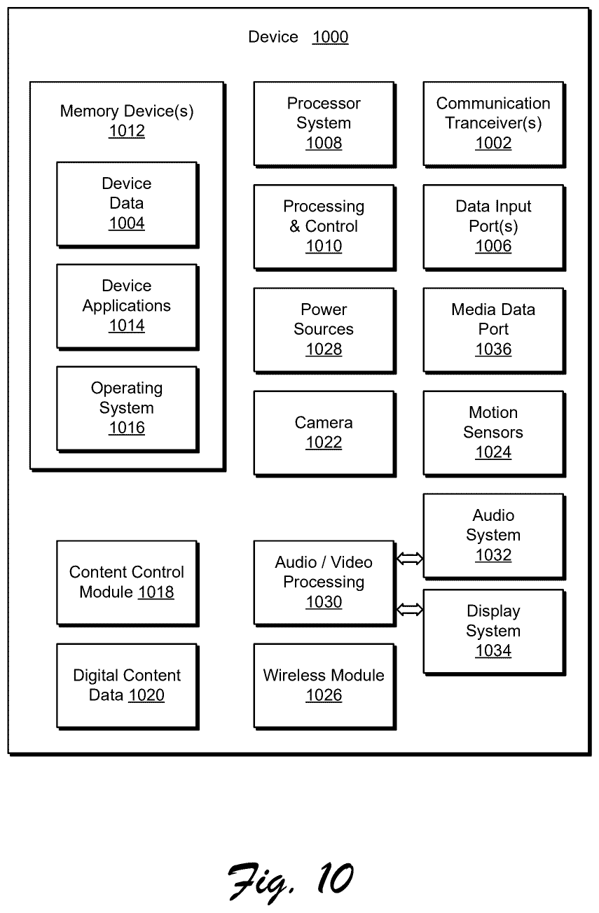

FIG. 1 illustrates an example environment 100 in which aspects of managing shared content based on link status can be implemented. The environment 100 includes a computing device such as a client device 102 and a network-based content sharing platform 104 that are interconnectable via network(s) 106. In the illustrated example, the client device 102 is depicted as a portable device that can be carried by a user 108, however this is by way of example and not limitation. The client device 102 can be implemented in a variety of different ways and form factors such as a smartphone, a tablet device, a laptop computer, desktop computer, a wearable computing device, (e.g., a smartwatch or a fitness tracker), augmented reality (“AR) and/or virtual reality (“VR”) devices (e.g., AR/VR glasses, projectors, headsets, etc.), a docked mobile device connected to a monitor, and so forth. Example attributes of the client device 102 are discussed below with reference to the device 1000 of FIG. 10.

The content sharing platform 104 may include a variety of network-based services and/or applications that enable users to create, upload, share, and/or interact with digital content. In some aspects, the content sharing platform 104 may include one or more social media platforms, blogging sites, video sharing websites, image hosting services, messaging services, and/or collaborative content creation tools. The platform may support various types of digital content, including but not limited to text posts, images, videos, audio files, hyperlinks, interactive media, etc. In some cases, the content sharing platform 104 may provide features such as user profiles, content feeds, commenting systems, and/or content recommendation algorithms.

The content sharing platform 104 may also include analytics tools that track user engagement, content performance, trending topics, and so forth. Additionally, the content sharing platform 104 may offer integration with third-party applications and services to enhance functionality and user experience. In various aspects, the content sharing platform 104 may support multiple device types and operating systems, enabling users to access and interact with shared content across desktop computers, mobile devices, and other internet-connected devices. It should be understood that in various aspects, the content sharing platform 104 may perform same or substantially similar functionality as the client device 102 and the client device 102 is likewise capable of performance of same or substantially similar functionality as the content sharing platform 104.

The client device 102 includes various functionality and components that enable the client device 102 to perform different aspects of managing shared content based on link status as discussed herein, including a connectivity module 110, a display screen 112, one or more applications 114, and a content control module 116. The connectivity module 110 represents functionality (e.g., logic and hardware) for enabling the client device 102 to interconnect with other devices and/or networks, such as the content sharing platform 104 and/or the network 106. The connectivity module 110, for instance, enables wireless and/or wired connectivity of the client device 102 to the content sharing platform 104, such as to transmit digital content between the client device 102 and the content sharing platform 104.

The display screen 112 represents functionality (e.g., hardware and logic) for enabling visual output via the client device 102, for instance, via a user interface 118. The user interface 118, for instance, includes one or more visual, auditory, and/or tactile elements that enable the user 108 to interact with digital content displayed by the client device 102. The display screen 112 and the user interface 118 are configurable with a variety of settings, such as display settings (e.g., resolution, aspect ratio, refresh rate, contrast, color profile, scaling, orientation), processing settings (e.g., upscaling/downscaling, image processing modes, computational resources usage and delegation, refresh rate, power-saving modes, overdrive settings to increase pixel response times, etc.), and/or interface settings, e.g., menu layouts, navigation, language settings, on-screen display settings, input sensitivity and responsiveness, theme, selectable indicia positioning and/or sizing, accessibility settings, input method customizations, etc.

In various examples, the display screen 112 further includes one or more input mechanisms 120. The input mechanisms 120 represent functionality for enabling input to the client device 102, such as user input to invoke functionality of the client device 102. The input mechanisms 120 can include functionality for receiving proximity-based input to the client device 102, such as stylus input, user touch input, contactless input based on proximity of a user's finger and/or a stylus to the client device 102, and so forth. In various examples, the input mechanisms 120 include one or more touch sensors and/or touch screens. This is by way of example and not limitation, and the input mechanisms 120 can include and/or support one or more of a virtual keyboard, voice input components, environmental sensors, motion gestures, biometric sensors, etc.

The one or more applications 114 represent functionality for performing different computing tasks via the client device 102, such as social media and/or content sharing, messaging and/or communication, gaming (e.g., mobile and/or touch-based gaming), media consumption (e.g., content streaming), productivity tasks (e.g., word processing, content generation, data analysis, etc.), web browsing, interaction with other devices, and so forth.

The applications 114, for instance, include an application 122 configured for a content sharing task. The application 122, for example, supports creation, upload, distribution, and/or management of a variety of digital content (e.g., images, videos, audio, posts, documents, etc.) across a networked system, e.g., the content sharing platform 104. For instance, the content-sharing platform supports display and/or configuration of an application interface 124 that corresponds to the application 122. The application interface 124 is displayable by the display screen 112 as well as via displays of one or more additional computing devices.

The content control module 116 represents functionality for performing various aspects of managing shared content based on link status as described herein. As described in more detail below, the content control module 116 is operable to receive and/or generate one or more instances of digital content 126, such as for presentation by the content sharing platform 104. A variety of digital content 126, is considered such as but not limited to posts, images, videos, audio files, hyperlinks, interactive media, embedded content or media, documents, and so forth. The digital content 126 may include various combinations of these content types, and may be adapted for different platforms, devices, and/or user preferences. In some cases, the digital content 126 may also incorporate metadata, tags, or other descriptive information to enhance discoverability and organization within the content sharing platform 104.

In one example, the digital content 126 includes a hyperlink 128. As used herein, the hyperlink 128 may refer to a reference and/or navigational element included in the digital content 126 that, when activated, navigates to destination content 130, e.g., to an additional location or resource, such as a webpage, document, media file, image, video, etc. The hyperlink 128 may be represented by text, images, embedded within various media, or other interactive elements within the digital content 126. In various examples, the hyperlink 128 is not visually depicted.

The content control module 116 is configured to monitor validity of the hyperlink 128 within the digital content 126, such as while the digital content 126 is shared on the content sharing platform 104. In an example the content control module 116 detects that the hyperlink 128 is invalid, e.g., the hyperlink 128 no longer leads to the intended destination content 130 and/or returns an error when executed. This may occur due to various reasons, such as the destination content 130 being removed, relocated, modified, or changes implemented in a hosting server's configuration. In some cases, the hyperlink 128 may become invalid due to temporary network issues, server downtime, or excessive computational resource consumption. As further described in more detail below, the content control module 116 may employ various methods to determine the validity of the hyperlink 128, including but not limited to checking HTTP status codes, analyzing page content, verifying a presence of expected elements on the linked page, based on interaction data with the digital content 126, etc.

Based on a detection that the hyperlink 128 is invalid, the content control module 116 is operable to generate updated digital content 132 that includes an alternative hyperlink 134 to lead to the destination content 130. For instance, the content control module 116 initiates a search process to identify the alternative hyperlink 134 that leads to similar or related destination content 130. As described in more detail below, the content control module 116 may utilize cached metadata and/or content summaries to efficiently compare potential replacements to identify the alternative hyperlink 134.

Upon identifying a suitable alternative hyperlink 134, the content control module 116 may generate the updated digital content 132 by replacing the invalid hyperlink 128 with the alternative hyperlink 134. The updated digital content 132 may then be automatically published to the content sharing platform 104, maintaining relevance and accessibility of the shared information without requiring manual intervention from the user.

In some implementations, the content control module 116 may also manage scenarios where no suitable alternative hyperlink 134 is available. For instance, the content control module 116 removes the digital content 126 from display and/or generates a notification for display by the display screen 112 that indicates a status of the hyperlink 128 and/or a change in status of the hyperlink 128. The content control module 116 may periodically reassess validity of the hyperlink 128 and update cached content to ensure ongoing accuracy and relevance of shared information.

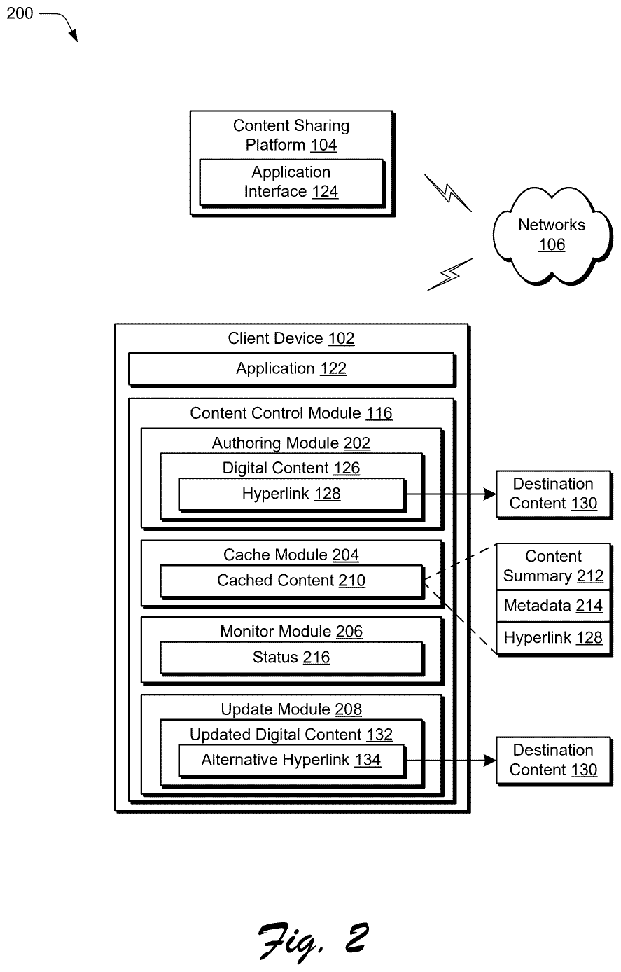

FIG. 2 depicts an example system 200 for managing shared content based on link status in accordance with one or more implementations. The system 200 can be implemented in the environment 100 and incorporates attributes of the environment 100 introduced above.

In the illustrated example, the client device 102 and the content sharing platform 104 are interconnected via the network 106, such as described above with respect to the environment 100. The client device 102 includes functionality to execute various applications 114, including the application 122. In at least one example, the application 122 includes a content sharing application such as a social media application and/or a messaging application. The content sharing platform 104 includes functionality to support display of an application interface 124 related to the application 122.

The content control module 116 is depicted to include several sub-modules that work together to manage shared content and various hyperlinks such as an authoring module 202, a cache module 204, a monitor module 206, and an update module 208. These modules interact with various types of data, including digital content 126, cached content 210, and updated digital content 132 as described in the following examples.

For example, the authoring module 202 is configured to generate an instance of digital content 126, such as for presentation by the content sharing platform 104. As described above, the digital content 126 may include a variety of digital content such as text, images, articles, digital videos, etc. In at least one example, the content sharing platform 104 may include one or more social media platforms and/or texting services and the digital content 126 is representative a social media “post.”

A post may refer to an instance of digital content 126 that is shared on a social media platform and/or content sharing platform 104. A post may include text, images, videos, hyperlinks, and/or other media that a user shares with their network or followers. In some implementations, a post may allow for user interactions such as comments, likes, or shares. Posts may be displayed, e.g., in the application interface 124, in a chronological feed or curated based on relevance algorithms. The content and format of a post may vary depending on properties and features of the particular content sharing platform 104.

In some examples, the digital content 126 includes a hyperlink 128 associated with destination content 130. For instance, selection of the hyperlink 128 causes navigation to the destination content 130, such as by the client device 102 and/or one or more additional devices that interact with the digital content 126 via the application interface 124 supported by the content sharing platform 104. The navigation may occur within the same application or browser window, while in other cases it may open a new tab or window. The destination content 130 may include various types of digital media such as web pages, articles, images, videos, or other interactive content. Once generated, the client device 102 communicates the instance of digital content 126 to the content sharing platform 104 to be shared, e.g., to be displayed in the application interface 124 such that additional computing devices may access, view, and/or interact with the digital content 126.

The cache module 204 is operable to generate cached content 210 and further is operable to cause the cached content 210 to be cached, such as by the client device 102. In various examples, caching includes storing the cached content 210 in a temporary storage location for quick access and/or retrieval. The cache module 204 can cause the cached content 210 to be stored in various locations alternative to or in addition to the client device 102 such as the content sharing platform 104, which may maintain a cache of frequently accessed content to reduce server load and improve response times. Additionally or alternatively, the cache module 204 caches the cached content 210 in one or more content delivery networks (CDN's), internet service provider (ISP) caches, web browsers on various devices, proxy servers, cloud-based caching services, edge computing nodes, etc. In some implementations, the cached content 210 is distributed across multiple caching locations, with different caching strategies applied based on factors such as content type, access patterns, and network conditions.

Generally, the cached content 210 represents a resource non-intensive representation of the destination content 130 and/or the hyperlink 128 that is configured to include searchable parameters that simplify retrieval of alternative hyperlinks 134 as further described in more detail below. The cached content 210, for instance, includes one or more of a representation of the hyperlink 128, one or more content summaries 212, and/or metadata 214 associated with the hyperlink 128 and/or the destination content 130.

The metadata 214 can include a variety of information such as content type (e.g., article, image, video, audio) of the destination content 130, title or headline of the destination content 130, author or creator information, publication date or last modified date, keywords or tags associated with the destination content 130, brief description or summary of the destination content 130, file size and format, language of the destination content 130, copyright or licensing information, source or domain of the destination content 130, geolocation data, thumbnail images or preview content, social media engagement metrics (e.g., number of likes, shares, reactions), content categories or topics, related links or recommended content, reading time or content length, accessibility features or alternative text descriptions, content rating or age restrictions, version information or revision history, technical specifications (e.g., resolution for images, bitrate for videos), digital images/videos, and so forth.

The cache module 204 may be configured to extract the metadata 214 through various techniques. In some implementations, the cache module 204 may analyze the destination content 130 associated with the hyperlink 128 to identify relevant metadata 214. This analysis may involve parsing HTML tags, examining file headers, and/or utilizing content analysis algorithms to extract a variety of information. In some examples, the cache module 204 utilizes APIs provided by the content hosting platforms to retrieve the metadata 214. The cache module 204 may also employ natural language processing techniques to extract additional contextual information from the destination content 130 itself.

The cache module 204 may further prioritize particular types of metadata 214 based on factors such as storage limitations, and/or search optimization requirements. For example, the cache module 204 may prioritize storing metadata 214 related to keywords and content topics to facilitate more efficient searching for alternative hyperlinks 134. In an alternative or additional example, the cache module 204 may prioritize caching metadata 214 related to content type and publication date to enable rapid filtering of potential alternative hyperlinks 134 while conserving computational resources. The cache module 204 is further operable to store the metadata 214 in a structured format within the cached content 210, allowing for efficient retrieval and comparison when searching for alternative hyperlinks 134.

In some implementations, the cached content 210 further includes a content summary 212 of the destination content 130. The content summary 212, for instance, includes a condensed representation of the destination content 130 that captures key elements and/or main ideas of the destination content 130 in a concise format. The content summary 212 may encompass various aspects of the destination content 130 such as a brief textual description, key phrases or topics, statistics or data points, and/or relevant contextual information. In some cases, the content summary 212 may also include visual elements like thumbnail images, video keyframes, or infographic snippets that represent the destination content 130.

The cache module 204 can generate the content summary 212 based on different types of destination content 130. For destination content 130 that includes textual content, the content summary 212 may include an abstract or executive summary. For destination content 130 that includes visual content, the content summary 212 may include a low-resolution preview image and/or a collection of representative frames. Audio content summaries 212 may include transcribed snippets or audio segments. The content summary 212 may also incorporate metadata 214 such as author information, publication date, and content categories to provide additional context.

The cache module 204 is operable to generate the content summary 212 in a variety of ways. For instance, the cache module 204 may utilize computer vision techniques to identify salient frames or regions in visual content, e.g., destination content that includes digital images and/or video. For text-based destination content, the cache module 204 may implement one or more natural language processing algorithms and/or models to extract sentences and/or generate abstractive summaries.

For example, the cache module 204 leverages natural language processing techniques to analyze text to identify relevant concepts, ideas, phrases, and/or strings, etc. The cache module 204 leverages the extracted information to create the content summary 212. In various implementations, the cache module 204 may utilize techniques such as sentence scoring, topic modeling, and/or machine learning-based summarization to generate the content summary 212. Additionally or alternatively, the cache module 204 may also leverage existing summary data provided by content publishers or utilize third-party summarization services to generate the content summary 212.

In some implementations, the cache module 204 may train and/or implement one or more machine learning models to generate content summaries 212 that capture relevant information while reducing computational resource consumption when cached and accessed. For instance, the cache module trains and/or implements a machine learning model to extract relevant features and concepts from the destination content 130 to create concise representations that facilitate effective retrieval of alternative hyperlinks 134.

By way of example and not limitation, the cache module 204 is configurable to train one or more machine learning models on large datasets of diverse content types to learn optimal summarization strategies for different media formats. Additionally, the models may be trained to incorporate user engagement data to prioritize information that is likely to be relevant for identifying suitable alternative hyperlinks 134. For instance, the cache module 204 may analyze metrics such as click-through rates, time spent viewing linked content, and social media interactions to determine which aspects of the destination content 130 are engaging to users. In this way, the techniques described herein support retrieval of relevant replacement links that maintain an original context and intent of the shared digital content 126.

The cache module 204 may further dynamically adjust a level of detail in the content summaries 212 based on factors such as available storage space, network conditions, and/or a likelihood of a change in status of the hyperlink 128. In this way, the client device 102 may generate resource-efficient content summaries 212 that minimize storage and processing requirements while including sufficient information for effective alternative hyperlink retrieval.

The cache module 204 is further operable to dynamically update the cached content 210, such as while the digital content 126 is shared by the content sharing platform. For instance, the cache module 204 is operable to periodically refresh the metadata 214 and/or the content summary 212 to reflect changes in the destination content 130. By way of example, the destination content 130 is modified and the cache module 204 detects the changes and update the cached content 210 accordingly.

Additionally or alternatively, the cache module 204 may track user interactions with the digital content 126, such as comments, likes, or shares, and incorporate this engagement data into the cached content 210. The cache module 204 may further prioritize types of metadata 214 included in the cached content 210 based on factors such as relevance to the sharing context, storage limitations, or search optimization requirements when dynamically updating the cached content 210. This continuous updating process ensures that the cached content 210 remains an accurate and up-to-date representation of the destination content 130, which increases efficiency in identification of suitable alternative hyperlinks.

In various examples, the cache module 204 is configured to delete the cached content 210 based on various criteria. For instance, the cache module 204 may implement a time-based expiration policy, where cached content 210 is automatically deleted after a threshold amount of time to ensure that recent and relevant information is retained. In some examples, the cache module 204 may delete cached content 210 based on storage constraints, such as to prioritize removal of infrequently accessed cached content 210. The cache module 204 may also delete cached content 210 when the associated digital content 126 is removed from the content sharing platform 104 and/or when the hyperlink 128 has been determined to be invalid in accordance with the techniques described below.

In at least one example, the cache module 204 deletes the cached content 210 based on interaction data with the digital content 126. By way of example, the digital content 126 includes a social media post, and the interaction data indicates that an engagement and/or a rate of engagement with the post is below a threshold level. The cache module 204 is thus operable to delete the cached content 210 associated with the post to conserve storage and/or processing resources. Such dynamic management of cached content 210 helps maintain an efficient and up-to-date cache, optimizes storage utilization, and ensures that relevant information is readily available for an alternative hyperlink retrieval process.

The monitor module 206 is configured to monitor a status 216 of the hyperlink 128, such as while the digital content 126 is presented by and/or accessible via the content sharing platform 104. The status 216, for instance, indicates whether the hyperlink is “active” or “inactive.” An active status indicates that the hyperlink 128 is functional and leads to accessible and intended destination content 130 when activated. Conversely, an inactive status suggests that the hyperlink 128 is no longer valid, due to factors such as content removal, URL changes, server issues, copyright issues, and so forth that result in inhibited access the intended destination content 130.

The monitor module 206 may employ various methods to check the status of the hyperlink 128. In some implementations, the monitor module 206 may periodically send HTTP requests to the hyperlink 128 and analyze response codes. For instance, a “200 OK” response may indicate an active status, while “404 Not Found” or “500 Internal Server Error” responses may suggest an inactive status. The monitor module 206 may also analyze destination content 130 associated with the hyperlink 128 to verify the presence of expected elements or keywords. In this way, the monitor module 206 is configured to detect situations where the hyperlink 128 remains valid but the destination content 130 has changed significantly and/or been removed. The monitor module 206 may also utilize third-party link checking services or APIs to validate the status of the hyperlink 128.

In various examples, the monitor module 206 periodically checks the validity of the hyperlink 128, such as at predetermined intervals. Additionally or alternatively, the monitor module 206 assesses the status 216 responsive to detection of one or more triggers, such as interaction data with the digital content 126. For instance, the monitor module 206 checks the status 216 responsive to one or more comments, likes, shares, user engagement metrics, and so forth with the digital content 126.

In various implementations, the monitor module 206 analyzes the interaction data to infer the status 216 of the hyperlink 128. For example, an increase in user reports or comments indicating difficulty accessing the linked content may trigger the monitor module 206 to assess the status 216. Additionally, the monitor module 206 may monitor engagement metrics such as click-through rates or time spent on a linked page, as changes in these metrics may indicate potential issues with the hyperlink 128. In at least one example, the monitor module 206 determines the status 216 responsive to identification of one or more keywords in one or more comments associated with the digital content 126, such as keywords that indicate the hyperlink 128 is not valid.

In one or more implementations, the monitor module 206 determines the status 216 of the hyperlink 128 based on computational resource usage associated with accessing the destination content 130. For instance, the monitor module 206 may track metrics such as loading time, memory usage, or processor utilization when attempting to access the destination content 130. If these metrics exceed predetermined thresholds, the monitor module 206 may classify the hyperlink 128 as invalid, even if the destination content 130 is technically accessible. In such cases, the content control module 116 may initiate a search for an alternative hyperlink 134 that leads to similar destination content 130 however utilizes relatively less computational resources to access. In this way, the techniques described herein maintain a balance between content relevance and system performance, ensuring that shared links do not negatively impact user experience or device functionality due to excessive resource consumption.

The update module 208 is configured to perform one or more actions based on the status 216. In an example in which the status 216 indicates the hyperlink 128 is valid, the update module 208 is operable to cause the cache module 204 to update the cached content 210. In an example in which the status 216 indicates the hyperlink 128 is not valid, the update module 208 is configured to search for an alternative hyperlink 134 associated with the destination content 130 based on the cached content 210.

The update module 208 may employ various strategies to search for the alternative hyperlink 134 based on the cached content 210. In some implementations, the update module 208 generates a search query using elements from the cached content 210, such as one or more of the content summary 212 and/or the metadata 214. The search query, for instance, may include relevant keywords, phrases, and/or topics extracted from the destination content 130, as well as other identifying information such as author names, publication dates, content categories, etc. included in the metadata 214. The update module 208 may further utilize one or more search engines, content aggregators, and/or specialized APIs to execute the search query and retrieve candidate hyperlinks to replace the hyperlink 128.

Once one or more candidate hyperlinks are identified, the update module 208 may analyze content associated with each candidate hyperlink to determine a similarity to the initial destination content 130. For instance, the update module 208 is configured to compare the metadata 214, content summaries 212, and/or other relevant information stored in the cached content 210 with content associated with the candidate hyperlinks. The update module 208 may generate various similarity metrics to assess a relevance and/or suitability of each candidate hyperlink. For instance, the update module determines whether one or more of the candidate hyperlinks have similarity scores above a similarity threshold to identify the alternative hyperlink 134.

In some implementations, the update module 208 may prioritize candidate hyperlinks that match multiple criteria from the cached content 210, such as content topic, author, publication date range, and content length. The update module 208 may also consider factors like a reputation of the source, recency of the content, and/or an overall quality of the content during selection of an alternative hyperlink 134. In an example in which multiple suitable candidate hyperlinks are identified, the update module 208 is configured to rank the candidate hyperlinks such as based on similarity scores or other relevant factors. By utilizing the pre-processed and condensed information stored in the cached content 210, the update module 208 is operable to perform rapid comparisons and filtering operations without re-analyzing the destination content 130 for each candidate hyperlink which increases computational efficiency.

In one or more examples in which the update module 208 identifies a suitable alternative hyperlink 134, the update module 208 updates the digital content 126 to include the alternative hyperlink 134 and generate updated digital content 132. For example, the update module 208 may identify a suitable alternative hyperlink 134 that leads to content substantially similar to the original destination content 130. The update module 208 then replaces the original hyperlink 128 in the digital content 126 with the alternative hyperlink 134. In this way, the update module 208 generates the updated digital content 132 to maintain an original context and intent of the shared information while providing a valid and accessible link to the destination content 130.

In one or more examples, the update module 208 determines that a suitable alternative hyperlink 134 is not available. In such examples, the update module 208 may remove the instance of digital content 126 from display by the content sharing platform 104. Additionally, the update module 208 may generate a notification for display by the display screen 112 that indicates the status of the hyperlink 128.

In this way, the techniques described herein maintain integrity of shared information included in the digital content 126, prevent access to outdated or irrelevant content, and reduce a spread of misinformation that could result from broken or invalid links. Removing digital content with invalid hyperlinks further improves a user experience by ensuring that shared content remains accessible and current. In this way, the techniques described herein preserve credibility of both the content sharing platform 104 and the original poster, e.g., a user 108.

Further, the techniques described herein may conserve system and/or network resources in various ways such as to directly improve operation of computing devices and/or data networks. For example, storing condensed versions of destination content 130 as cached content 210 may reduce storage requirements, and enable additional content items to be cached without excessive strain on device or server resources. The resource non-intensive representation further enables efficient search operations via support of rapid matching on metadata 214 or content summaries 212 rather than processing full-scale content.

When searching for alternative hyperlinks, using lightweight cached content improves bandwidth efficiency by reducing an amount of data transferred. Additionally, using condensed representations when comparing candidate hyperlinks utilizes reduced computational power, which support efficient use of device resources. By leveraging these advantages, systems that implement the techniques described herein can perform efficient and effective searches for alternative hyperlinks 134.

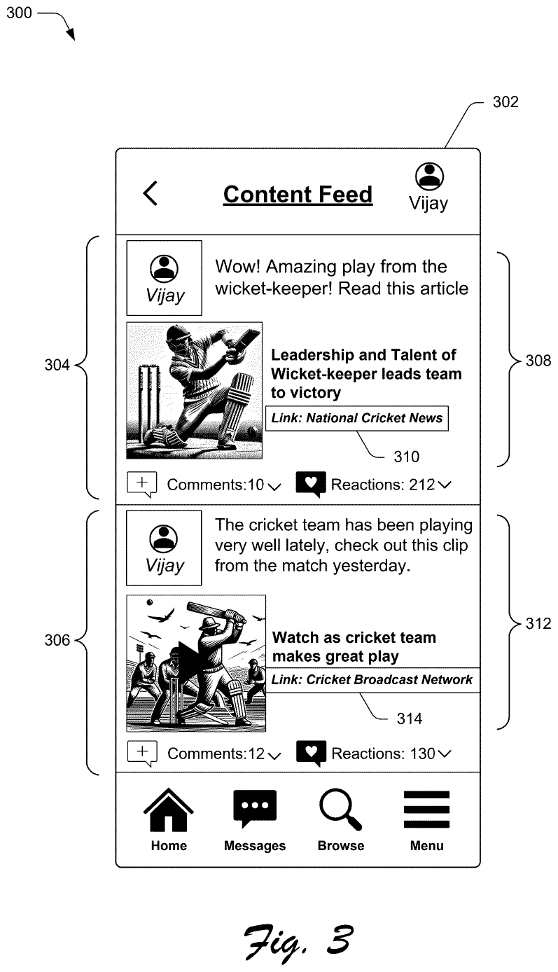

FIG. 3 depicts an example implementation 300 for managing shared content based on link status in accordance with one or more implementations. The example implementation 300 includes an example interface 302 displaying multiple posts, e.g., instances of digital content 126 generated by the client device 102 and configured for presentation by the content sharing platform 104, e.g., in an application interface 124.

For instance, a first post 304 is shown in the example interface 302 that includes user generated text as well as first post content 308 related to a cricket match. The first post content 308 includes various digital content such a digital image, an article title, and a first hyperlink 310 labeled as “Link: National Cricket News.” Selection of the first hyperlink 310, for instance, leads to destination content 130 that provides access to the article. While the first hyperlink 310 is depicted visually, this is by way of example and not limitation and in various examples a hyperlink 128 is not visually included in the digital content 126.

Below the first post 304, a second post 306 is displayed in the example interface 302. The second post 306 contains user generated text as well as second post content 312 that pertains to a performance of the cricket team, along with a digital video. The second post 306 includes a second hyperlink 314 labeled as “Link: Cricket Broadcast Network.” Selection of the second hyperlink 314 navigates to destination content 130 that includes the second post content 312, e.g., the digital video.

In accordance with the techniques described herein, the content control module 116 is operable to generate cached content 210 for the first post 304 as well as cached content 210 for the second post 306. The cached content 210 includes metadata 214 about the posts and the respective hyperlinks, as well as content summaries 212 of the destination content 130 linked by the first hyperlink 310 and the second hyperlink 314.

The client device 102 is further configured to periodically update the cached content 210 while the instances of digital content 126 are presented by the content sharing platform 104 such as by updating the metadata 214 and/or content summaries 212 to reflect changes in the destination content 130 and/or to represent user interactions with the posts. The example interface 302 also depicts interaction metrics for the first post 304 and the second post 306, such as comment counts and reaction counts. The interaction metrics may be triggers for the monitor module 206 to check the status 216 of the first hyperlink 310 and the second hyperlink 314, in accordance with the techniques described above.

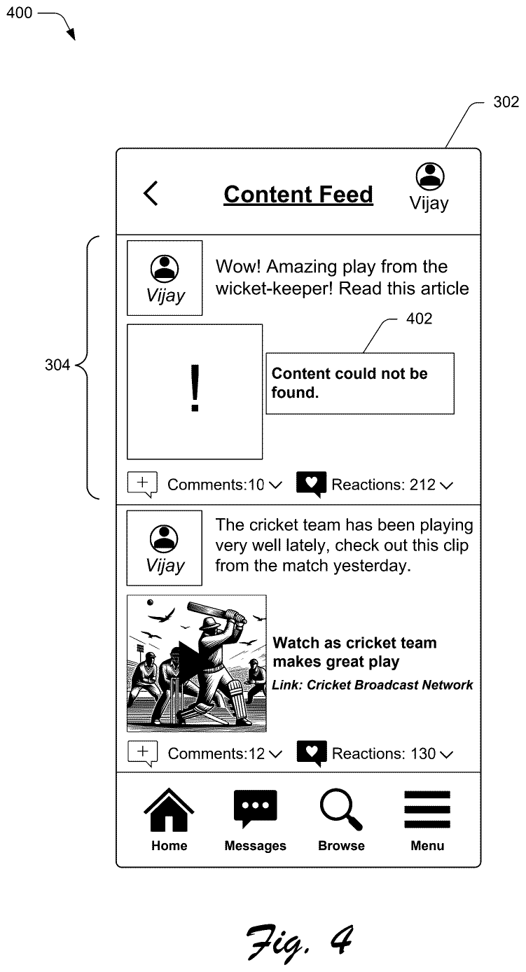

FIG. 4 depicts an example implementation 400 for managing shared content based on link status in which a hyperlink has become invalid accordance with one or more implementations. The example implementation 400, for instance, is a continuation of the example implementation 300 described above with respect to FIG. 3.

As illustrated, the example interface 302 displays a scenario in which the shared content of the first post 304 has become inaccessible, e.g., the first hyperlink 310 has become invalid. In the illustrated example, the client device 102 depicts an error message 402 in place of the previously visible first post content 308, indicating “content could not be found.” This error message indicates that the destination content 130 related to the first post 304 can no longer be accessed.

The illustrated example highlights limitations of conventional techniques, as users are left without context or alternative means to view the first post content 308, which disrupts a flow of conversation and/or information sharing within the example interface 302 and further results in expenditure of unnecessary computational resources. To overcome these limitations, the content control module 116 leverages the cached content 210 to identify an alternative hyperlink 134 and/or take other remedial actions to maintain the integrity and relevance of the shared information.

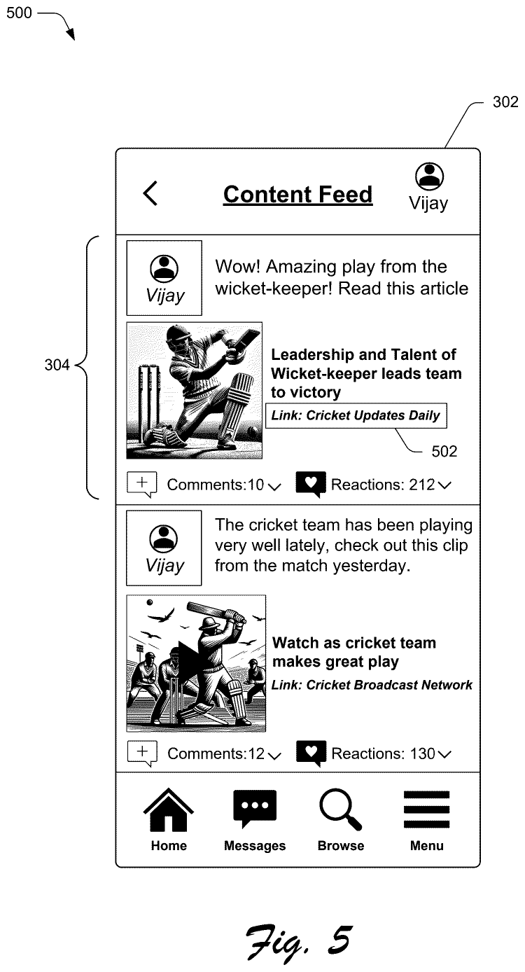

For instance, FIG. 5 depicts an example implementation 500 for managing shared content based on link status in which an alternative hyperlink is identified in accordance with one or more implementations. The example implementation 500, for instance, is a continuation of the example implementations described above with respect to FIGS. 3-4.

In the illustrated example, the content control module 116 leverages the cached content 210, including metadata 214 and content summaries 212 associated with the first post 304, to search for and identify an alternative to the first hyperlink 310, e.g., an updated hyperlink 502. For instance, the content control module 116 generates a search query based on the cached content 210, e.g., the article title, subject matter, source, author, a summary of the content, etc. In accordance with the techniques described above, the content control module 116 identifies the updated hyperlink 502 as a suitable alternative that leads to substantially similar destination content 130 as the first hyperlink 310, e.g., a substantially similar article.

Upon identification of the updated hyperlink 502 as a suitable alternative hyperlink 134, the content control module 116 dynamically updates the first post 304 to include the updated hyperlink 502 automatically and without manual intervention from the user 108. The content control module 116 further updates metadata 214 based on the changes, such that the cached content 210 remains current and accurate for future reference. Accordingly, the example interface 302 displays updated digital content 132 that includes a revised version of the first post 304. For instance, the content control module 116 replaces the previously invalid first hyperlink 310 with the updated hyperlink 502. Selection of the updated hyperlink 502 causes navigation to valid destination content 130 that includes the above referenced cricket article, thereby resolving the issue of the broken hyperlink identified in FIG. 4.

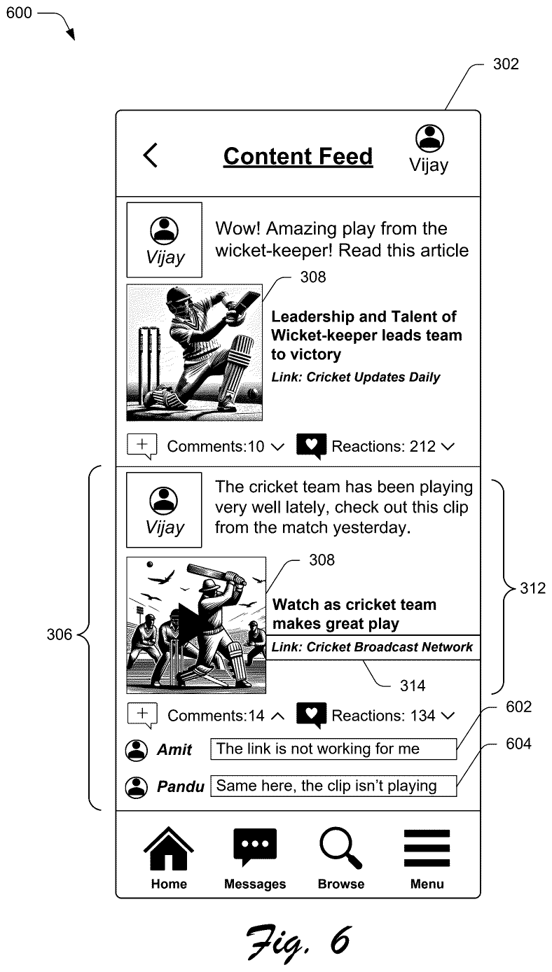

FIG. 6 depicts an example implementation 600 for managing shared content based on link status in which a hyperlink has become invalid accordance with one or more implementations. The example implementation 600, for instance, is a continuation of the example implementations described above with respect to FIGS. 3-5.

The example interface 302 displays a scenario where the second hyperlink 314 associated with the second post 306 has become invalid. In this example, the content control module 116 checks the validity of the second hyperlink 314 based on interaction data with the digital content 126 as displayed by the content sharing platform 104.

For instance, the interaction data includes a first comment 602 and a second comment 604 associated with the second post 306. The content control module 116 is operable to analyze these comments to identify keywords indicating that the second hyperlink 314 is not valid. For instance, the first comment 602 states “The link is not working for me,” while the second comment 604 states “Same here, the clip isn't playing.”

The comments serve as triggers for the content control module 116 to validate the status 216 of the second hyperlink 314. In addition to comments, the content control module 116 may consider other forms of interaction data such as views, reactions, shares, and/or other user engagement metrics associated with the second post 306. For example, a sudden decrease in engagement and/or an increase in negative reactions may prompt the content control module 116 to verify the status 216 of the second hyperlink 314.

In this example, the content control module 116 determines that the second hyperlink 314 is no longer valid. Based on the determination, the content control module 116 is operable to initiate a search for an alternative hyperlink 134 and/or take remedial action to maintain the integrity of the second post content 312. By leveraging user interactions to monitor the status of shared hyperlinks, the content control module 116 may efficiently detect and address issues with invalid links, thereby maintaining the relevance and accessibility of shared content on the content sharing platform 104.

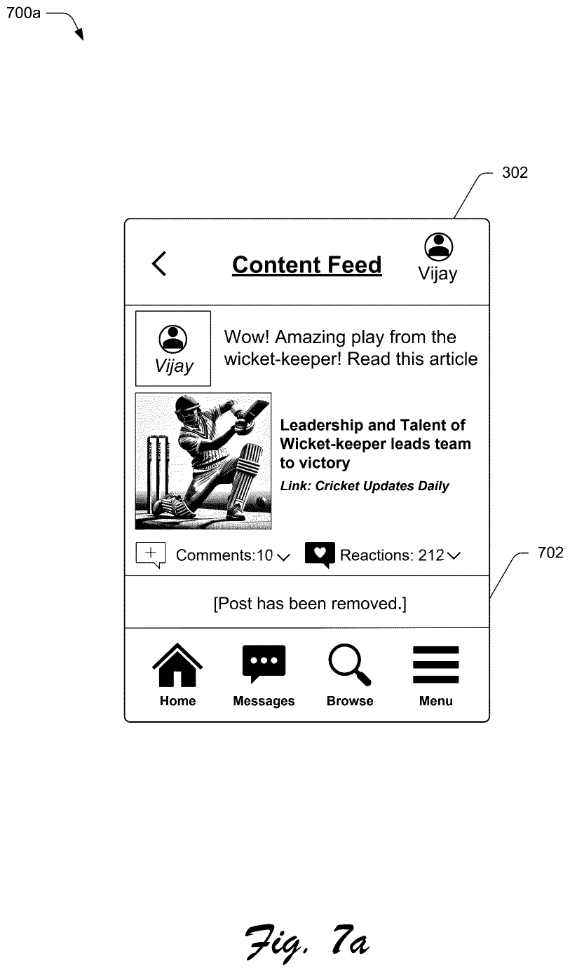

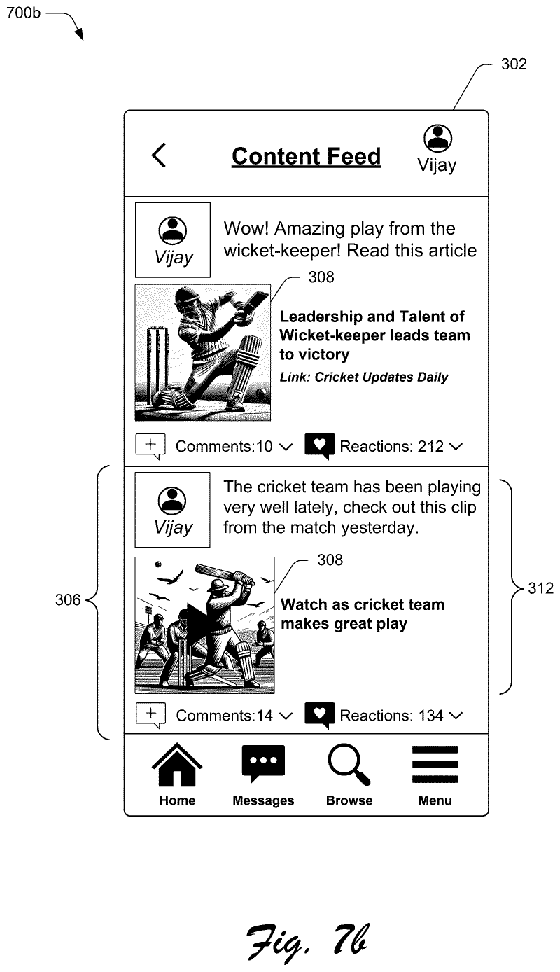

FIG. 7a depicts an example implementation 700a for managing shared content based on link status in which an instance of digital content with an invalid hyperlink is removed from display in accordance with one or more implementations. The example implementation 700a, for instance, is a continuation of the example implementations described above with respect to FIGS. 3-6.

In this example, the content control module 116 has determined that an alternative hyperlink 134 is not available to replace the invalid second hyperlink 314 associated with the second post 306. As a result, the content control module 116 has caused the second post 306 to be removed from display by the content sharing platform 104.

In some examples, the content control module 116 further generates a notification that indicates a status 216 of the hyperlink 128. For instance, the example interface 302 includes a removal notice 702 in place of the previously displayed second post 306. The removal notice 702 informs the user 108 that the second post 306 has been deleted, such as due to lack of an appropriate replacement link. For example, the removal notice 702 states “post has been removed” to clearly communicate the status 216 of the second hyperlink 314 to users of the content sharing platform 104. By displaying the removal notice 702, the system 200 informs users about the unavailability of previously shared content and helps maintain transparency in content management on the content sharing platform 104.

FIG. 7a depicts an example implementation 700b for managing shared content based on link status in which an invalid hyperlink is removed from display in accordance with one or more implementations. The example implementation 700b, for instance, is a continuation of the example implementations described above with respect to FIGS. 3-6. The example implementation 700b, for instance, represents an alternative or additional action responsive to detection that the second hyperlink 314 has become inactive.

Similar to the above example implementation 700a, in this example the content control module 116 has determined that an alternative hyperlink 134 is not available to replace the invalid second hyperlink 314 associated with the second post 306. As a result, the content control module 116 causes the second hyperlink 314 to be removed from the second post 306, rather than remove the second post 306 entirely from display by the content sharing platform 104.

For instance, as depicted the interface 302 includes the second post 306, however, the second hyperlink 314 has been removed. The second post 306 still includes the first post content 308 such as the thumbnail and the video title. In some implementations, the first post content 308 is represented in the cached content 210, and thus the content control module 116 is able to retrieve and display the first post content 308 despite the fact that the second hyperlink 314 is inactive.

The content control module 116 can remove various portions of the second post 306 based on detection of the inactive second hyperlink 314. In at least one example, the content control module 116 removes the thumbnail and the video title leaving just the user generated text. In some implementations, the content control module 116 is further operable to edit the text of the second post 306 automatically and without user intervention based on detection of the inactive second hyperlink 314. For example, the content control module 116 can edit the text to remove mention of the hyperlink and/or video, such as to revise the second post 306 to include text “The cricket team has been playing very well lately!” In this way, the techniques described herein prevent user confusion by removal of reference to an inactive hyperlink.

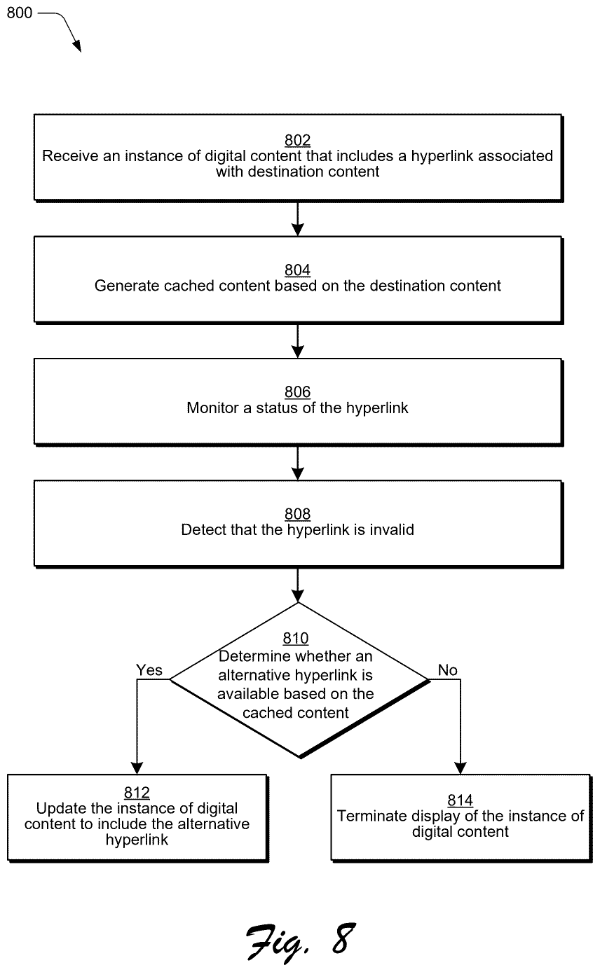

FIG. 8 depicts a flow chart depicting an example method 800 for managing shared content based on link status in accordance with one or more implementations. Operations of the method 800, for instance, may be performed in the context of the environment 100, such as by the client device 102 and/or the content sharing platform 104.

At 802, an instance of digital content that includes a hyperlink associated with destination content is received. The instance of digital content 126 may be generated the client device 102 for presentation by the content sharing platform 104. In some cases, the instance of digital content 126 may include a social media post containing text, images, embedded media, and/or other media along with the hyperlink 128 that leads to the destination content 130 and is configured to be shared by the content sharing platform 104, e.g., one or more social media platforms.

At 804, cached content is generated based on the destination content. For instance, the client device 102 generates the cached content 210 to include a representation of the hyperlink 128 and/or metadata 214 associated with the destination content 130. In some examples, the cached content 210 also includes a content summary 212 that provides a condensed representation of the destination content 130. The cached content 210 allows for efficient retrieval and comparison when searching for alternative hyperlinks.

At 806, a status of the hyperlink is monitored. The client device 102 may periodically check the validity of the hyperlink while the instance of digital content is presented by and/or accessible via the content sharing platform 104. In some cases, the monitoring may be triggered by interactions with the digital content, such as one or more comments or engagement metrics. The client device 102 is further operable to update the cached content 210 such as while the hyperlink 128 remains valid.

At 808, a detection that the hyperlink is invalid is made. For instance, the client device 102 determines that the hyperlink 128 is no longer functional, e.g., the destination content 130 is no longer accessible via selection of the hyperlink 128. In at least one example, the client device 102 determines the hyperlink 128 is invalid based on a determination that a computational resource usage associated with accessing the destination content 130 is above a threshold level.

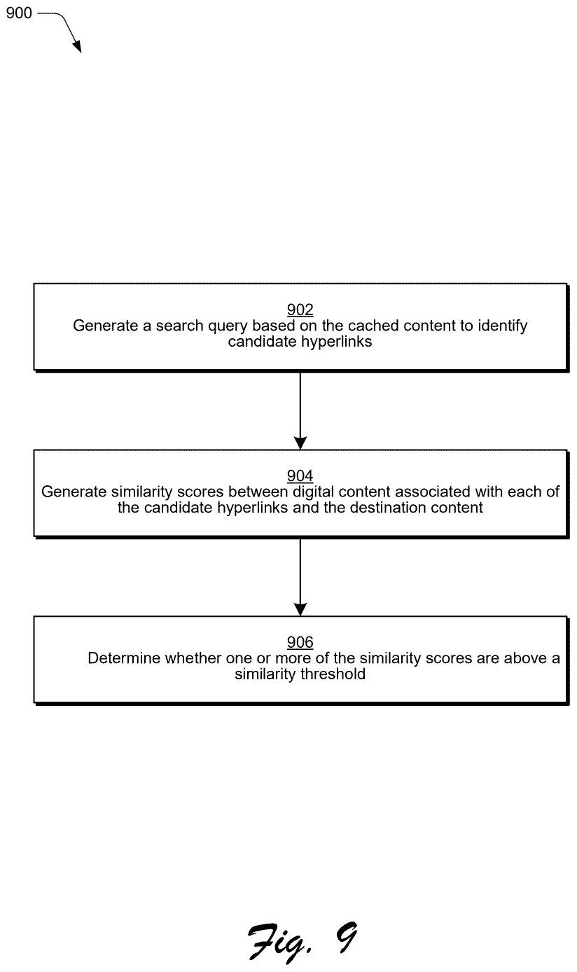

At 810, a determination is made whether an alternative hyperlink is available. The client device 102 may search for an alternative hyperlink 134 based on the cached content 210. In some examples, the client device 102 generates a search query based on the cached content 210 to search for the alternative hyperlink 134. The client device 102 can then analyze whether candidate alternative hyperlinks lead to substantially similar destination content 130 as the hyperlink 128. This is described in more detail below with respect to FIG. 9.

At 812, if an alternative hyperlink is available (e.g., “Yes” at 810), the instance of digital content is updated to include the alternative hyperlink. The client device 102, for instance, replaces the invalid hyperlink 128 with the alternative hyperlink 134 in the digital content 126 to generate the updated digital content 132. This process may occur automatically and without manual intervention.

At 814, if an alternative hyperlink is not available (e.g., “No” at 810), the display of the instance of digital content is terminated. The client device 102 may remove the instance of digital content 126 from display by the content sharing platform 104. Additionally, a notification may be generated that indicates the change in status 216 of the hyperlink 128, such as to inform users about the removal of the content due to an invalid hyperlink.

Accordingly, the method 800 provides a systematic approach to maintain integrity and relevance of shared content via mitigation of issues with invalid hyperlinks. By leveraging cached content and automated processes for location of alternative hyperlinks, the method 800 enhances a user experience and reduces a spread of outdated or inaccessible information on the content sharing platform 104.

FIG. 9 depicts a flow chart depicting an example method 900 for managing shared content based on link status in which availability of an alternative hyperlink is determined in accordance with one or more implementations. In various examples, one or more steps of the example method 900 are implemented as one or more substeps of the example method 800, such as substeps of step 810. The method 900, for instance, describes an example to identify whether a suitable alternative hyperlink 134 is available.

At 902, a search query is generated based on cached content to identify candidate hyperlinks. For instance, the client device 102 utilizes the cached content 210 (which can include metadata 214 and/or content summaries 212 associated with the original destination content 130) to formulate a search query. For example, the client device 102 may extract key terms, phrases, or topics from the content summary 212 to combine with relevant metadata 214 such as author names, publication dates, or content categories to create a comprehensive search query. The query is constructed to efficiently and accurately locate candidate hyperlinks that lead to content similar to the original destination content 130.

At 904, similarity scores are generated between digital content associated with each of the candidate hyperlinks and the destination content. The client device 102, for instance, analyzes the content linked by each candidate hyperlink identified in step 902 and compares the content to the original destination content 130. The client device 102 can leverage various techniques to analyze the content such as text analysis, image recognition, and/or semantic comparison, depending on the type of content. The client device 102 generates a similarity score for each candidate hyperlink that quantifies how closely the destination content of each candidate hyperlink matches the original destination content 130. The similarity scores may be based on factors such as content overlap, thematic similarity, structural resemblance, and/or other relevant metrics.

At 906, a determination is made whether one or more of the similarity scores are above a similarity threshold. For instance, the client device 102 evaluates the similarity scores generated in step 904 against a predefined similarity threshold. This threshold represents a minimum level of similarity required for a candidate hyperlink to be considered a suitable alternative to the hyperlink 128. The threshold may be set based on various factors such as a type of content, an importance of accuracy in a particular context, user preferences, etc. If one or more candidate hyperlinks have similarity scores above this threshold, the client device 102 may proceed to select a most suitable alternative hyperlink, e.g., a candidate hyperlink with a highest similarity score. If no candidate hyperlinks have a similarity score above the threshold, the client device 102 may determine that no suitable alternative hyperlink 134 is available.

In some cases, the client device 102 may identify a particular candidate hyperlink as the alternative hyperlink 134 based on the similarity score. For example, the client device 102 may select the candidate hyperlink with the highest similarity score above the threshold as the alternative hyperlink 134. Alternatively, the client device 102 may consider additional factors beyond just the similarity score, such as a reliability of a source, a recency of the content, or a popularity of the linked page, when making the final selection of the alternative hyperlink 134.

In this way, the client device 102 is operable to systematically identify and evaluate potential alternative hyperlinks 134 and ensure that a selected alternative hyperlink 134 leads to content that closely resembles the destination content 130. In this way, the techniques described herein are implementable to maintain integrity and relevance of shared content on the content sharing platform 104.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 10 illustrates various components of an example device 1000 in which aspects of managing shared content based on link status can be implemented. The example device 1000 can be implemented as any of the devices described with reference to the previous FIGS. 1-9, such as any type of mobile device, mobile phone, mobile device, wearable device, tablet, computing, communication, entertainment, gaming, media playback, and/or other type of electronic device. For example, the client device 102 as shown and described with reference to FIGS. 1-9 may be implemented as the example device 1000.

The device 1000 includes communication transceivers 1002 that enable wired and/or wireless communication of device data 1004 with other devices. The device data 1004 can include any of device identifying data, device location data, wireless connectivity data, and wireless protocol data. Additionally, the device data 1004 can include any type of audio, video, and/or image data. Example communication transceivers 1002 include wireless personal area network (WPAN) radios compliant with various IEEE 1002.15 (Bluetooth™) standards, wireless local area network (WLAN) radios compliant with any of the various IEEE 1002.11 (Wi-Fi™) standards, wireless wide area network (WWAN) radios for cellular phone communication, wireless metropolitan area network (WMAN) radios compliant with various IEEE 1002.16 (WiMAX™) standards, and wired local area network (LAN) Ethernet transceivers for network data communication.

The device 1000 may also include one or more data input ports 1006 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1000 includes a processing system 1008 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1010. The device 1000 may further include any type of a system bus or other data and command transfer system that couples the various components within the device. A system bus can include any one or combination of different bus structures and architectures, as well as control and data lines.

The device 1000 also includes computer-readable storage memory 1012 (e.g., memory devices) that enable data storage, such as data storage devices that can be accessed by a computing device, and that provide persistent storage of data and executable instructions (e.g., software applications, programs, functions, and the like). Examples of the computer-readable storage memory 1012 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1000 may also include a mass storage media device.

The computer-readable storage memory 1012 provides data storage mechanisms to store the device data 1004, other types of information and/or data, and various device applications 1014 (e.g., software applications). For example, an operating system 1016 can be maintained as software instructions with a memory device and executed by the processing system 1008. The device applications may also include a device manager, such as any form of a control application, software application, signal-processing and control module, code that is native to a particular device, a hardware abstraction layer for a particular device, and so on. Computer-readable storage memory 1012 represents media and/or devices that enable persistent and/or non-transitory storage of information in contrast to mere signal transmission, carrier waves, or signals per se. Computer-readable storage memory 1012 do not include signals per se or transitory signals.

In this example, the device 1000 includes a content control module 1018 that implements aspects of managing shared content based on link status and may be implemented with hardware components and/or in software as one of the device applications 1014. In an example, the content control module 1018 can be implemented as the content control module 116 described in detail above. In implementations, the content control module 1018 may include independent processing, memory, and logic components as a computing and/or electronic device integrated with the device 1000. The device 1000 also includes digital content data 1020 for implementing aspects of managing shared content based on link status and may include data from and/or utilized by the content control module 1018.

In this example, the example device 1000 also includes a camera 1022 and motion sensors 1024, such as may be implemented in an inertial measurement unit (IMU). The motion sensors 1024 can be implemented with various sensors, such as a gyroscope, an accelerometer, and/or other types of motion sensors to sense motion of the device. The various motion sensors 1024 may also be implemented as components of an inertial measurement unit in the device.

The device 1000 also includes a wireless module 1026, which is representative of functionality to perform various wireless communication tasks. For instance, for the client device 102, the wireless module 1026 can be leveraged to scan for and detect wireless networks, as well as negotiate wireless connectivity to wireless networks for the client device 102. The device 1000 can also include one or more power sources 1028, such as when the device is implemented as a mobile device. The power sources 1028 may include a charging and/or power system, and can be implemented as a flexible strip battery, a rechargeable battery, a charged super-capacitor, and/or any other type of active or passive power source.

The device 1000 also includes an audio and/or video processing system 1030 that generates audio data for an audio system 1032 and/or generates display data for a display system 1034. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1036. In implementations, the audio system and/or the display system are integrated components of the example device. Alternatively, the audio system and/or the display system are external, peripheral components to the example device.

Although implementations of managing shared content based on link status have been described in language specific to features and/or methods, the subject of the appended claims is not necessarily limited to the specific features or methods described. Rather, the features and methods are disclosed as example implementations of managing shared content based on link status, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a client device including: at least one memory; and at least one processor coupled with the at least one memory and configured to cause the client device to: generate an instance of digital content for presentation by a network-based content sharing platform, the instance of digital content including a hyperlink associated with destination content; generate cached content that includes the hyperlink and metadata associated with the destination content; monitor a status of the hyperlink while the instance of digital content is accessible via the network-based content sharing platform to determine that the hyperlink is invalid; and update, based at least in part on the cached content, the instance of digital content to include an alternative hyperlink associated with the destination content.

In some aspects, the techniques described herein relate to a client device, wherein the instance of digital content includes a social media post that includes embedded content and the network-based content sharing platform includes one or more social media platforms.

In some aspects, the techniques described herein relate to a client device, wherein the cached content further includes a content summary that includes a condensed representation of the destination content.

In some aspects, the techniques described herein relate to a client device, the client device further configured to delete the cached content after a threshold amount of time.

In some aspects, the techniques described herein relate to a client device, the client device further configured to periodically update the cached content while the instance of digital content is presented by the network-based content sharing platform.

In some aspects, the techniques described herein relate to a client device, wherein to monitor the status of the hyperlink includes identifying one or more keywords in one or more comments associated with the instance of digital content that indicates the hyperlink is not valid.

In some aspects, the techniques described herein relate to a client device, wherein to monitor the status of the hyperlink includes determining that the destination content is no longer accessible via the hyperlink.

In some aspects, the techniques described herein relate to a client device, the client device further configured to identify the alternative hyperlink by generating a search query based on the cached content to identify one or more candidate hyperlinks and comparing the destination content to digital content associated with the one or more candidate hyperlinks.

In some aspects, the techniques described herein relate to a client device, wherein to identify the alternative hyperlink further includes identifying a candidate hyperlink of the one or more candidate hyperlinks that is associated with digital content that has a similarity score to the destination content above a threshold.

In some aspects, the techniques described herein relate to a method performed by a client device including: generating an instance of digital content for display by a network-based content sharing platform, the instance of digital content including a hyperlink associated with destination content; generating cached content that includes a representation of the hyperlink and metadata associated with the destination content; detecting, while the instance of digital content is accessible via the network-based content sharing platform, a change in status of the hyperlink from valid to invalid; determining, based on the cached content, whether an alternative hyperlink that is associated with the destination content is available; and updating the instance of digital content based on the determining.

In some aspects, the techniques described herein relate to a method, further including determining that the alternative hyperlink is available and wherein updating the instance of digital content includes replacing the hyperlink with the alternative hyperlink.

In some aspects, the techniques described herein relate to a method, further including determining that the alternative hyperlink is not available and wherein updating the instance of digital content includes causing the instance of digital content to be removed from display by the network-based content sharing platform.

In some aspects, the techniques described herein relate to a method, further including generating a notification for display by the client device that indicates the change in status of the hyperlink.

In some aspects, the techniques described herein relate to a method, wherein generating the cached content includes generating a content summary that includes a condensed representation of the destination content.

In some aspects, the techniques described herein relate to a method, wherein detecting the change in status of the hyperlink is based in part on interaction data with the instance of digital content as displayed by the network-based content sharing platform.

In some aspects, the techniques described herein relate to a method, wherein the interaction data includes one or more comments, likes, shares, or user engagement metrics with the instance of digital content.

In some aspects, the techniques described herein relate to a method, wherein determining whether the alternative hyperlink is available includes: generating a search query based on the cached content to identify candidate hyperlinks; generating similarity scores between digital content associated with each of the candidate hyperlinks and the destination content; and determining whether one or more of the similarity scores are above a similarity threshold.

In some aspects, the techniques described herein relate to a system including: at least one memory; and at least one processor coupled to the at least one memory and configured to cause the system to: detect that an instance of digital content displayed by a network-based content sharing platform includes a hyperlink associated with destination content; generate cached content that includes the hyperlink and metadata associated with the destination content; monitor a status of the hyperlink while the instance of digital content is displayed by the network-based content sharing platform; determine, responsive to a detection that the hyperlink is invalid and based on the cached content, that an alternative hyperlink associated with the destination content is not available; and cause the instance of digital content to be removed from display by the network-based content sharing platform.

In some aspects, the techniques described herein relate to a system, the at least one processor further configured to cause the system to generate a notification for display that indicates the hyperlink is invalid.

In some aspects, the techniques described herein relate to a system, wherein the cached content further includes a content summary that includes a condensed representation of the destination content.

1. A client device comprising:
at least one memory; and
at least one processor coupled with the at least one memory and configured to cause the client device to:
generate an instance of digital content for presentation by a network-based content sharing platform, the instance of digital content including a hyperlink associated with destination content;
generate cached content that includes the hyperlink and metadata associated with the destination content;
monitor a status of the hyperlink while the instance of digital content is accessible via the network-based content sharing platform to determine that the hyperlink is invalid; and
update, based at least in part on the cached content, the instance of digital content to include an alternative hyperlink associated with the destination content.

2. The client device of claim 1, wherein the instance of digital content includes a social media post that includes embedded content and the network-based content sharing platform includes one or more social media platforms.

3. The client device of claim 1, wherein the cached content further includes a content summary that includes a condensed representation of the destination content.

4. The client device of claim 1, the client device further configured to delete the cached content after a threshold amount of time.

5. The client device of claim 1, the client device further configured to periodically update the cached content while the instance of digital content is presented by the network-based content sharing platform.

6. The client device of claim 1, wherein to monitor the status of the hyperlink includes identifying one or more keywords in one or more comments associated with the instance of digital content that indicates the hyperlink is not valid.

7. The client device of claim 1, wherein to monitor the status of the hyperlink includes determining that the destination content is no longer accessible via the hyperlink.

8. The client device of claim 1, the client device further configured to identify the alternative hyperlink by generating a search query based on the cached content to identify one or more candidate hyperlinks and comparing the destination content to digital content associated with the one or more candidate hyperlinks.

9. The client device of claim 8, wherein to identify the alternative hyperlink further includes identifying a candidate hyperlink of the one or more candidate hyperlinks that is associated with digital content that has a similarity score to the destination content above a threshold.

10. A method performed by a client device comprising:
generating an instance of digital content for display by a network-based content sharing platform, the instance of digital content including a hyperlink associated with destination content;
generating cached content that includes a representation of the hyperlink and metadata associated with the destination content;
detecting, while the instance of digital content is accessible via the network-based content sharing platform, a change in status of the hyperlink from valid to invalid;
determining, based on the cached content, whether an alternative hyperlink that is associated with the destination content is available; and
updating the instance of digital content based on the determining.

11. The method of claim 10, further comprising determining that the alternative hyperlink is available and wherein updating the instance of digital content includes replacing the hyperlink with the alternative hyperlink.

12. The method of claim 10, further comprising determining that the alternative hyperlink is not available and wherein updating the instance of digital content includes causing the instance of digital content to be removed from display by the network-based content sharing platform.

13. The method of claim 10, further comprising generating a notification for display by the client device that indicates the change in status of the hyperlink.

14. The method of claim 10, wherein generating the cached content includes generating a content summary that includes a condensed representation of the destination content.

15. The method of claim 10, wherein detecting the change in status of the hyperlink is based in part on interaction data with the instance of digital content as displayed by the network-based content sharing platform.

16. The method of claim 15, wherein the interaction data includes one or more comments, likes, shares, or user engagement metrics with the instance of digital content.

17. The method of claim 10, wherein determining whether the alternative hyperlink is available includes:
generating a search query based on the cached content to identify candidate hyperlinks;
generating similarity scores between digital content associated with each of the candidate hyperlinks and the destination content; and
determining whether one or more of the similarity scores are above a similarity threshold.

18. A system comprising:
at least one memory; and
at least one processor coupled to the at least one memory and configured to cause the system to:
detect that an instance of digital content displayed by a network-based content sharing platform includes a hyperlink associated with destination content;
generate cached content that includes the hyperlink and metadata associated with the destination content;
monitor a status of the hyperlink while the instance of digital content is displayed by the network-based content sharing platform;
determine, responsive to a detection that the hyperlink is invalid and based on the cached content, that an alternative hyperlink associated with the destination content is not available; and
cause the instance of digital content to be removed from display by the network-based content sharing platform.

19. The system of claim 18, the at least one processor further configured to cause the system to generate a notification for display that indicates the hyperlink is invalid.

20. The system of claim 18, wherein the cached content further includes a content summary that includes a condensed representation of the destination content.
